(19) United States
(12) Patent Application Publication
(10) Pub. No.: US 2007/0286512 A1
(43) Pub. Date: Dec. 13, 2007

(54) Encoding apparatus, encoding method, medium storing program and computer data signal

(75) Inventors: Taro Yokose, Ashigarakami-gun (JP); Masanori Sekino, Ashigarakami-gun (JP); Tomoki Taniguchi, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/594,059

(22) Filed: Nov. 8, 2006

(30) Foreign Application Priority Data
Jun. 13, 2006 (JP) 2006-163453

(51) Int. Cl. G06K 9/36

(52) U.S. Cl. 382/245

(57) ABSTRACT

An encoding apparatus includes a block dividing unit that divides an inputted data file into blocks each including plural data elements arranged in the order of encoding, a predicted data creating unit that creates predicted data for each of the blocks resulting from the division by the block dividing unit on the basis of data elements contained in other blocks, a comparing unit that compares the predicted data created by the predicted data creating unit with data elements contained in the blocks, and a code creating unit that creates codes for the inputted data file on the basis of results of the comparison by the comparing unit.

### BACKGROUND

1. Technical Field

The present invention relates to an encoding apparatus, an encoding method by which data files are encoded, a medium storing a program, and a computer data signal.

2. Related Art

For instance, a method is disclosed by which the processing of conversion into pattern run-length data is increased in speed by detecting the same two-dimensional patterns of image data in parallel and thereby obtaining pattern run-length data.

### SUMMARY

The present invention has been made in view of the background described above, and provides an encoding apparatus capable of encoding data file at high speed.

[Encoding Apparatus]

According to an aspect of the present invention, an encoding apparatus includes a block dividing unit that divides an inputted data file into blocks each including plural data elements arranged in the order of encoding, a predicted data creating unit that creates predicted data for each of the blocks resulting from the division by the block dividing unit on the basis of data elements contained in other blocks, a comparing unit that compares the predicted data created by the predicted data creating unit with data elements contained in the blocks, and a code creating unit that creates codes for the inputted data file on the basis of results of the comparison by the comparing unit.

### BRIEF DESCRIPTION OF THE DRAWINGS

An exemplary embodiment of the present invention will be described in detail based on the following figures, wherein:

FIG. 1 typically illustrates, with focus on a controller 21, the hardware configuration of an image processing device to which the encoding method according to an aspect of the present invention is adapted;

FIG. 2 typically illustrates the functional configuration of a first encoding program 5 to be executed by the controller 21 (FIG. 1) and thereby to realize the encoding method according to an aspect of the present invention;

FIGS. 3(A) to 3(C) illustrate a block-by-block run-length encoding system;

FIGS. 4(A) to 4(C) illustrate a method of block-by-block data comparison;

FIG. 5 is a flowchart of encoding (S10) by the encoding program 5 (FIG. 2);

FIG. 6 typically illustrates the functional configuration of a decoding program 6 to be executed by the controller 21 (FIG. 1);

FIG. 7 is a flowchart of decoding (S20) by the decoding program 6 (FIG. 6);

FIG. 8 is a flowchart of second encoding (S12);

FIGS. 9(A) to 9(C) illustrate a block-by-block predictive encoding system;

FIG. 10 typically illustrates the functional configuration of a second encoding program 52;

FIGS. 11(A) to 11(C) typically illustrate a method of creating predicted data;

FIG. 12 typically illustrates the functional configuration of a third encoding program 54; and

FIG. 13 typically illustrates a code table for use when the run-length encoding system and the predictive encoding system are combined.

### DETAILED DESCRIPTION

[Background and Outline]

First, the background of the present invention will be described to facilitate its understanding.

The run-length encoding system is an encoding system by which, where the same data elements appear consecutively in a data file, this group of data elements (runs) is expressed in data element values and the length of consecution (run-length). The following description will refer to encoding of image data as a specific example.

The predictive encoding system (in the narrow sense) is an encoding system by which pixel values are predicted and the resultant prediction errors are used as codes. The predictive encoding system is extensively used by virtue of its simplicity of processing, and the international standard JPEG-LS may be classified as a kind of this system. Incidentally, though the run-length encoding system is also considered a predictive encoding system in a broader sense, in the following description, the run-length encoding system will be distinguished from the predictive encoding system in the narrow sense.

While both the run-length encoding system and the predictive encoding system are extensively used, their basis of pixel-by-pixel processing makes it difficult to achieve higher speed.

In view of this problem, an image processing device 2 in this exemplary embodiment of the present invention, an inputted image is divided into blocks of a predetermined size, and each block is subjected to run-length conversion or predictive processing. Each pixel in the block is so configured as to permit processing independent of others. Since short feedbacks and branching are eliminated in this way and this arrangement may be used for parallel processing, raising the speed of encoding is facilitated.

Incidentally, while various shapes are conceivable for the block, data may be put into blocks in the sequence of encoding. Thus, when image data are to be encoded, pixel groups arrayed in the fast-scanning direction is treated as blocks. This is because, if a block containing multiple pixels in the slow-scanning direction is created, the size of the memory for buffering pixel values will have to be made greater.

[Hardware Configuration]

Next, the hardware configuration of the image processing device 2 in this exemplary embodiment will be described.

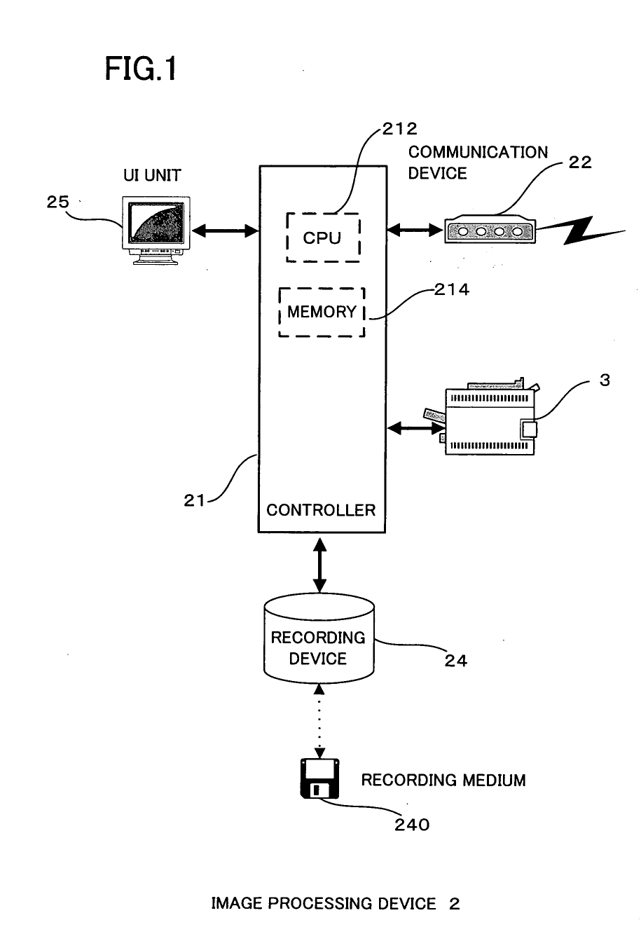

FIG. 1 typically illustrates, with focus on a controller 21, the hardware configuration of the image processing device 2 to which the encoding method according to an aspect of the present invention is adapted.

As illustrated in FIG. 1, the image processing device 2 includes the controller 21 further including a CPU 212 and a memory 214, a communication device 22, a recording device 24 such an HDD or CD unit, a user interface unit (UI unit) 25 further including an LCD display or CRT display and a keyboard or touch panel.

The image processing device 2 is disposed within a printer 3, and an encoding program 5 (to be described afterwards) and a decoding program 6 (to be described afterwards) are installed therein.

[Encoding Program]

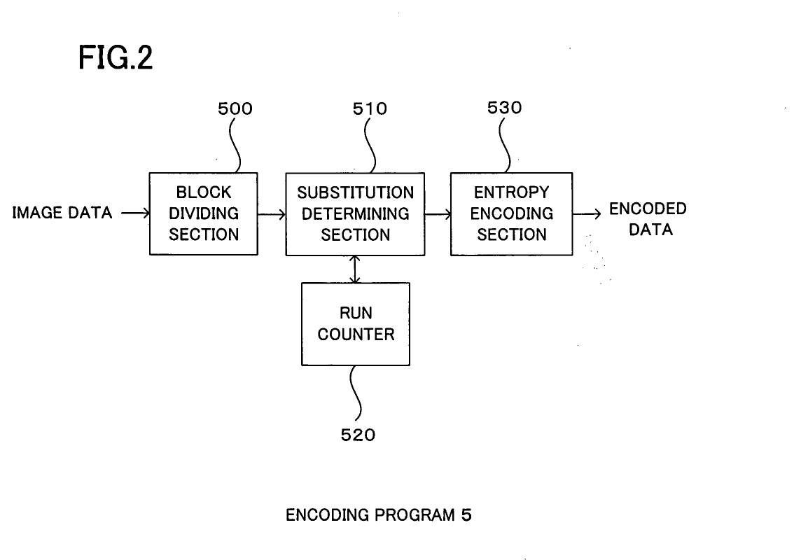

FIG. 2 typically illustrates the functional configuration of the first encoding program 5 to be executed by the controller 21 (FIG. 1) and thereby to realize the encoding method according to an aspect of the present invention. Incidentally, the following description will refer to a case in which the values of the pixels are expressed in eight bits as a specific example.

As illustrated in FIG. 2, the first encoding program 5 has a block dividing section 500, a substitution determining section 510, a run counter 520 and an entropy encoding section 530.

In the encoding program 5, the block dividing section 500 divides an inputted data file into blocks including multiple data elements arrayed in the sequence of encoding, and outputs the blocks resulting from the division to the substitution determining section 510.

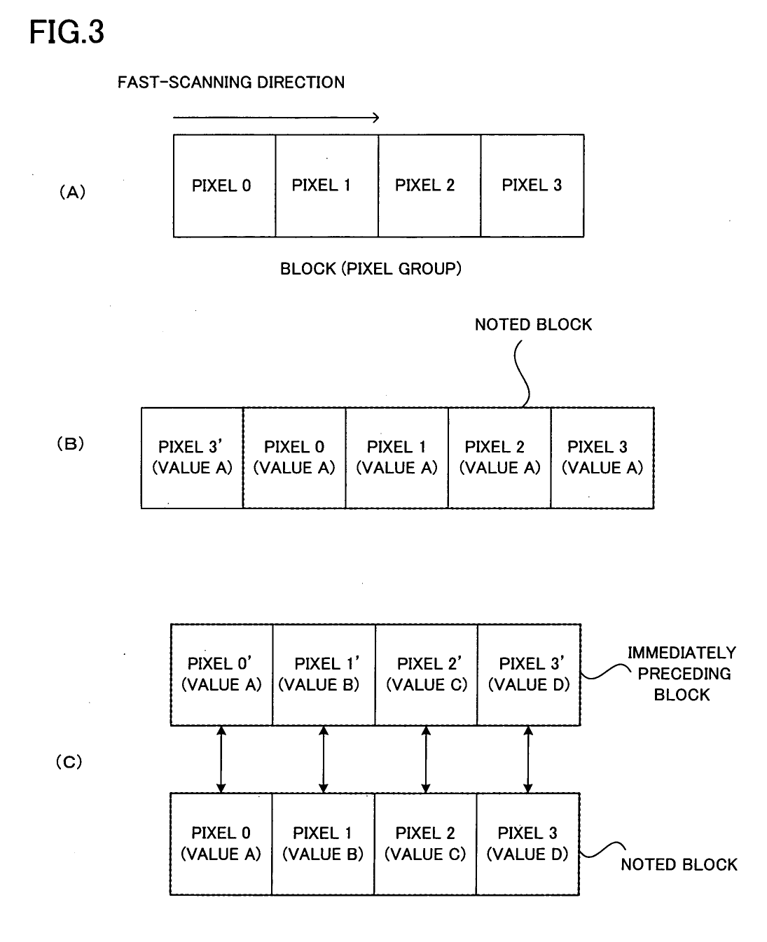

The block dividing section 500 in this example, as illustrated in FIG. 3(A), divides an inputted image into blocks including four pixels (pixel 0 through pixel 3) arrayed in the sequence of encoding, and outputs the image data (pixel values of pixel 0 through pixel 3) to the substitution determining section 510.

The substitution determining section 510 (a predicted data creating unit), when creating predicted data of a noted block, creates predicted data on the basis of data elements (pixel values) contained in other blocks.

The substitution determining section 510 in this example, as illustrated in FIG. 3(B), when creating predicted data corresponding to the pixel values of the noted block, makes the pixel value immediately preceding this noted block (the value of the pixel 3′) the predicted data. Thus the single pixel value contained in the immediately preceding block (the final pixel value) constitutes the predictive value of each of the pixels contained in the noted block.

Incidentally the substitution determining section 510, as illustrated in FIG. 3(C), when creating predicted data corresponding to the pixel values of the noted block, may as well make each of the pixel values contained in the block immediately preceding this noted block the predicted data. In other words, the predicted data corresponding to each of the pixels in the noted block may as well be the pixel value in the matching position in the immediately preceding block.

The substitution determining section 510 compares the created predicted data with each of the data elements (pixel values) contained in the noted block; if all the data elements are found identical with the predicted data, the substitution determining section 510 notifies the run counter 520 of the rightness of the prediction or, if any of the data elements is not found identical with the predicted data, notifies the run counter 520 of the wrongness of the prediction, and outputs the pixel values contained in this noted block as they are to the entropy encoding section 530 as symbols to be encoded.

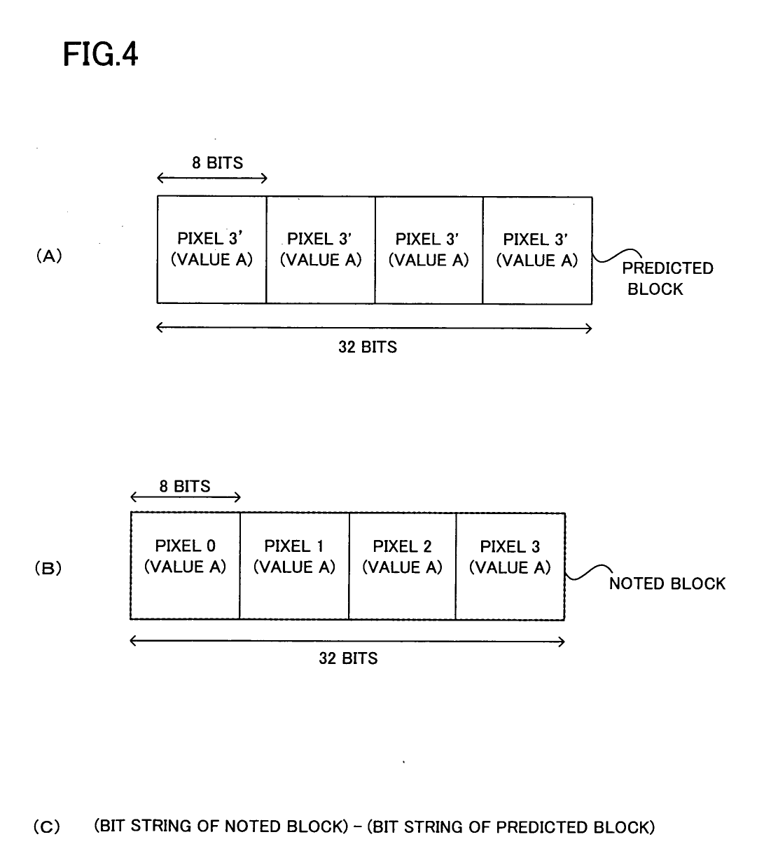

The substitution determining section 510 in this example, as shown in FIG. 4(A), creates a predicted block by arraying four immediately preceding pixel values, compares the bit string of the predicted block with bit string of the noted block (FIG. 4(B)); if these bit strings are found identical (namely the difference in FIG. 4(C) is 0), the substitution determining section 510 notifies the run counter 520 of the rightness of the prediction or, if they are not identical (namely the difference in FIG. 4(C) is not 0), notifies the run counter 520 of the wrongness of the prediction, and outputs the bit string (32 bits) of the noted block as symbols to be encoded to the entropy encoding section 530.

The run counter 520, when notified by the substitution determining section 510 of the rightness of the prediction, counts up the run-length (the number of consecutive right predictions) or, when the prediction is wrong, outputs the current count (the number of runs) to the substitution determining section 510. The substitution determining section 510, having received the input of the number of runs from the run counter 520, outputs the predicted data of this run count (the immediately preceding pixel value) and the number of runs as symbols to be encoded to the entropy encoding section 530.

The entropy encoding section 530 encodes, with variable-length codes, the predicted data and the number of runs inputted from the substitution determining section 510 or the pixel values of the noted block.

The entropy encoding section 530 in this example, when the predicted data and the number of runs are inputted from the substitution determining section 510, encodes the input predicted data and the number of runs or, when the bit string (32 bits) of the pixel group of the noted block are inputted, encodes this bit string.

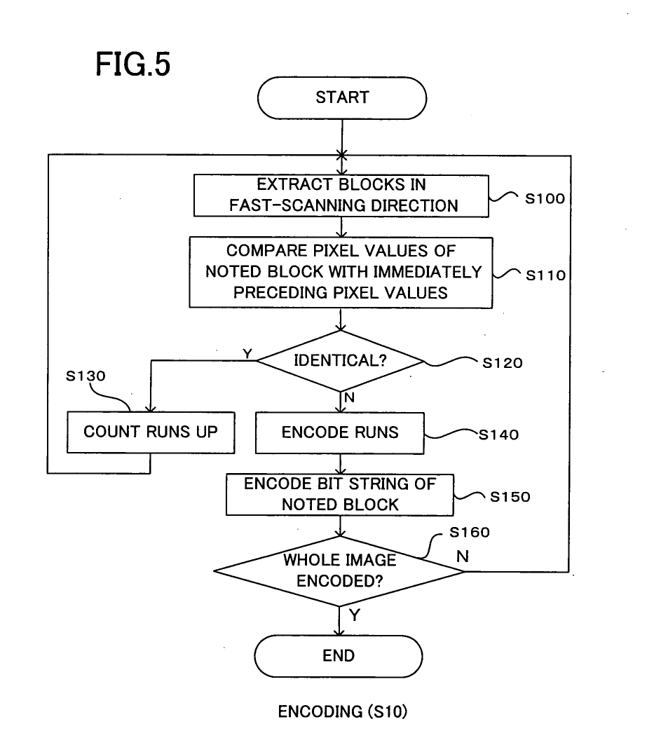

FIG. 5 is a flowchart of encoding (S10) by the encoding program 5 (FIG. 2).

As charted in FIG. 5, at step 100 (S100), the block dividing section 500 (FIG. 2) cuts out of the inputted image data four pixels in the order of scanning, and outputs the four cut-out pixels as the noted block to the substitution determining section 510.

At step 110 (S110), the substitution determining section 510, which is holding the final pixel value of the immediately preceding block (namely the pixel immediately preceding the noted block), compares in parallel the immediately preceding pixel value that is held with each pixel value of the noted block inputted from the block dividing section 500. More specifically, the substitution determining section 510 creates a bit string in which four immediately preceding pixels are arrayed (the bit string of a predicted block) as illustrated in FIG. 4(A), compares the bit string of the predicted block with the bit string of the noted block and, if these bit strings are found completely identical, notifies the run counter 520 of the rightness of the prediction or, if these bit string fail to be completely identical, outputs a notification of the wrongness of the prediction to the run counter 520.

At step 120 (S120), in the case of complete identification of the immediately preceding pixel value and every pixel value of the noted block (namely the rightness of the prediction), the encoding program 5 shifts to processing at S130 or, in the case of non-identification of the immediately preceding pixel value and any pixel value of the noted block, shifts to processing at S140.

At step 130 (S130) the run counter 520, when notified by the substitution determining section 510 of the rightness of the prediction, increases the run count by one. Incidentally, the initial run count is 0.

The encoding program 5, returning to processing at S100, cuts the next noted block out of the inputted image data. In the absence of the next noted block, exceptional processing is executed.

At step 140 (S140) the run counter 520, notified by the substitution determining section 510 of the wrongness of the prediction, outputs the run count to the substitution determining section 510 to initialize the count.

The substitution determining section 510 outputs to the entropy encoding section 530 the count (the number of runs) inputted from the run counter 520 and the predicted pixel value at the time (the immediately preceding pixel value) as symbols to be encoded.

The entropy encoding section 530 encodes with variable-length codes the number of runs and immediately preceding pixel value inputted from the substitution determining section 510.

At step 150 (S150), the substitution determining section 510, after outputting the number of runs and immediately preceding pixel value to the entropy encoding section 530, outputs the pixel group of the noted block to the entropy encoding section 530.

The entropy encoding section 530 encodes with variable-length codes the pixel group of the noted block inputted from the substitution determining section 510.

At step 160 (S160), the encoding program 5 judges whether or not all the inputted image data has been encoded and, if there is any unprocessed pixel, returns to processing at S100 or, if every pixel has been encoded, ends the encoding (S10).

[Decoding Program]

Next, the method of decoding the code data encoded as described above will be described.

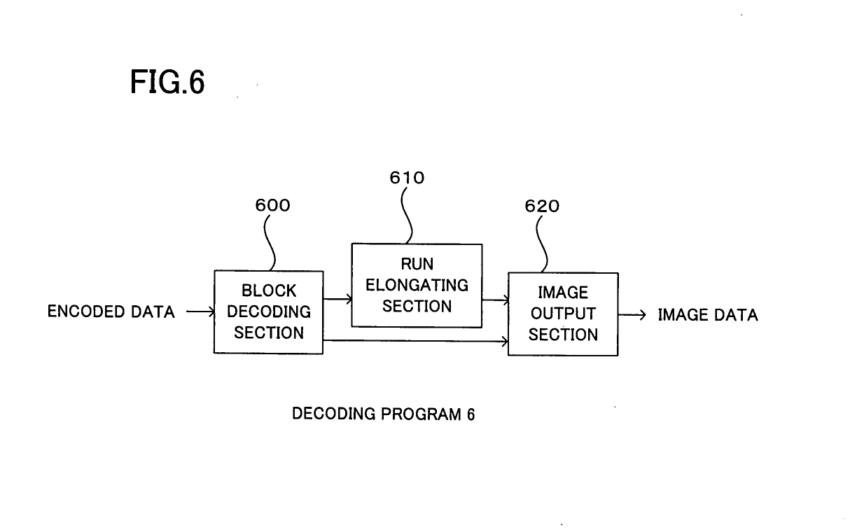

FIG. 6 typically illustrates the functional configuration of the decoding program 6 to be executed by the controller 21 (FIG. 1).

As illustrated in FIG. 6, the decoding program 6 has a block decoding section 600, a run elongating section 610 and an image output section 620.

In the decoding program 6, the block decoding section 600 decodes the input encoded data to create the decoded values of each block. Decoded values in this example are the pixel values (immediately preceding values), the number of runs for correctly predicted blocks and the pixel values of all the pixels contained in blocks for wrongly predicted blocks.

The block decoding section 600 in this example outputs the pixel values and the number of runs to the run elongating section 610, and the pixel values of all the pixels contained in blocks to the image output section 620.

The run elongating section 610 produces, according to the number of runs, copies of the pixel values inputted from the block decoding section 600, and outputs these pixels to the image output section 620 as the pixel values of the block.

The run elongating section 610 in this example produces as many copies of the inputted pixel values as (the number of runs)×(the number of pixels in the block), and outputs the copied pixel values to the image output section 620.

Incidentally, where the whole immediately preceding block and the whole noted block are directly compared and encoded as illustrated in FIG. 3(C), the run elongating section 610 produces as many copies of the immediately preceding block (namely the values of four pixels) as the number of runs and outputs the copied block to the image output section 620.

The image output section 620 divides the pixel group of the block inputted from the block decoding section 600 or the run elongating section 610 into individual pixels.

The image output section 620 in this example externally outputs the block inputted from the block decoding section 600 as four pixels.

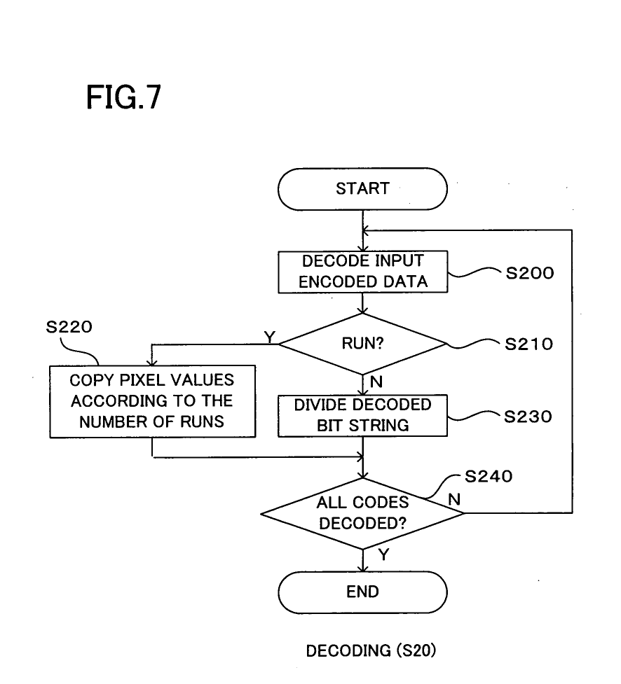

FIG. 7 is a flowchart of decoding (S20) by the decoding program 6 (FIG. 6).

As charted in FIG. 7, at step 200 (S200), the block decoding section 600 decodes the input encoded data from the leading code word onward. As many symbols are decoded as the number of runs and the pixel values or the pixel values of the pixel group contained in the block.

At step 210 (S210), the decoding program 6, if the decoded symbols are runs and pixel values, shifts to processing at S220 or, if the decoded symbols are the pixel values of the pixel group contained in the block, shifts to processing at S230.

At step 220 (S220), when the number of runs and the pixel values are inputted from the block decoding section 600, the run elongating section 610 produces as many copies of the pixel values as (the number of runs)×(the number of pixels in the block), and outputs the copied pixel values to the image output section 620.

The image output section 620 externally outputs as they are the multiple pixel values inputted from the run elongating section 610.

At step 230 (S230), when the pixel values of the pixel group contained in the block are inputted from the block decoding section 600, the image output section 620 externally outputs the pixel values of the inputted pixel group as the values of four pixels.

At step 240 (S240), the decoding program 6 judges whether or not all the encoded data has been decoded and, if there is any unprocessed code, returns to processing at S200 or, if all the encoded data has been decoded, ends the decoding (S20).

As described above the image processing device 2 in this exemplary embodiment, as it processes run-length encoding on a block-by-block basis, can increase the speed of encoding.

Incidentally, while in the foregoing exemplary embodiment the pixel values of the pixel group contained in the block are encoded as a single bit string in the event of run interruption (wrong prediction), these pixel values of the pixel group may as well be encoded pixel by pixel in parallel, and in this case the decoding of the values of the pixels can also be accomplished in parallel.

[First Variation]

Next, variations of this exemplary embodiment will be described.

In the exemplary embodiment described above, since runs are counted on a block-by-block basis, the runs have to be elongated in decoding by using (the number of runs)×(the number of pixels in the block), (the count)×(the number of pixels in the block) may as well be used as the number of runs in encoding. This would enable decoding to be accomplished by a pixel-by-pixel run-length system.

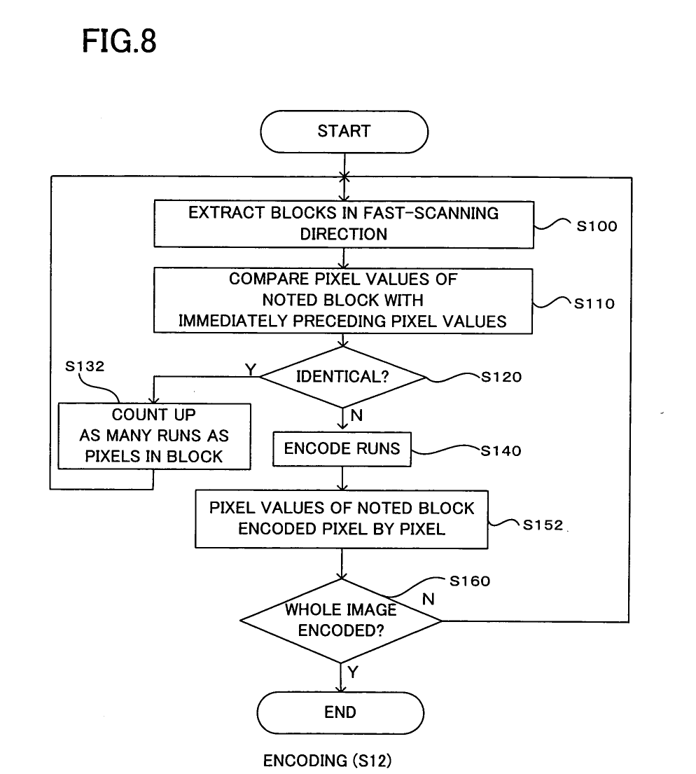

FIG. 8 is a flowchart of second encoding (S12). Incidentally, out of the steps of processing substantially the same as their counterparts in the processing charted in FIG. 5 are assigned respectively the same signs.

As charted in FIG. 8, at S100, the block dividing section 500 (FIG. 2) cuts out of the inputted image data four pixels in the order of scanning, and outputs the four cut-out pixels as the noted block to the substitution determining section 510.

At S110, the substitution determining section 510, which is holding the final pixel value of the immediately preceding block (the immediately preceding pixel value), compares in parallel the immediately preceding pixel value that is held with each pixel value of the noted block.

At S120, in the case of complete identification of the immediately preceding pixel value and every pixel value of the noted block, the encoding program 5 shifts to processing at S132 or, in the case of non-identification of the immediately preceding pixel value and any pixel value of the noted block, shifts to processing at S140.

At step 132 (S132) the run counter 520, notified by the substitution determining section 510 of the rightness of the prediction, increases the run count by the number of pixels in the block. In this example, as four pixels are contained in a block, it increases the count by four each time.

At S140, the run counter 520, notified by the substitution determining section 510 of the wrongness of the prediction, outputs the run count to the substitution determining section 510 to initialize the count.

The substitution determining section 510 outputs to the entropy encoding section 530 the count (the number of runs) inputted from the run counter 520 and the predicted pixel value at the time (the immediately preceding pixel value) as symbols to be encoded.

The entropy encoding section 530 encodes with variable-length codes the number of runs and immediately preceding pixel value inputted from the substitution determining section 510.

At step 152 (S152) the substitution determining section 510, after outputting the number of runs and immediately preceding pixel value to the entropy encoding section 530, outputs the pixel value group of the noted block to the entropy encoding section 530.

The entropy encoding section 530 encodes in parallel the pixel values of the noted block inputted from the substitution determining section 510.

At S160, the encoding program 5 judges whether or not all the inputted image data has been encoded and, if there is any unprocessed pixel, returns to processing at S100 or, if every pixel has been encoded, ends the encoding (S10).

The encoded data created in this way can be decoded by a conventional run-length decoding system.

[Variation 2]

While the foregoing exemplary embodiment is described with reference to a form in which run-length encoding is processed on a block-by-block basis, a second variation will be described with reference to a form in which predictive encoding is processed on a block-by-block basis.

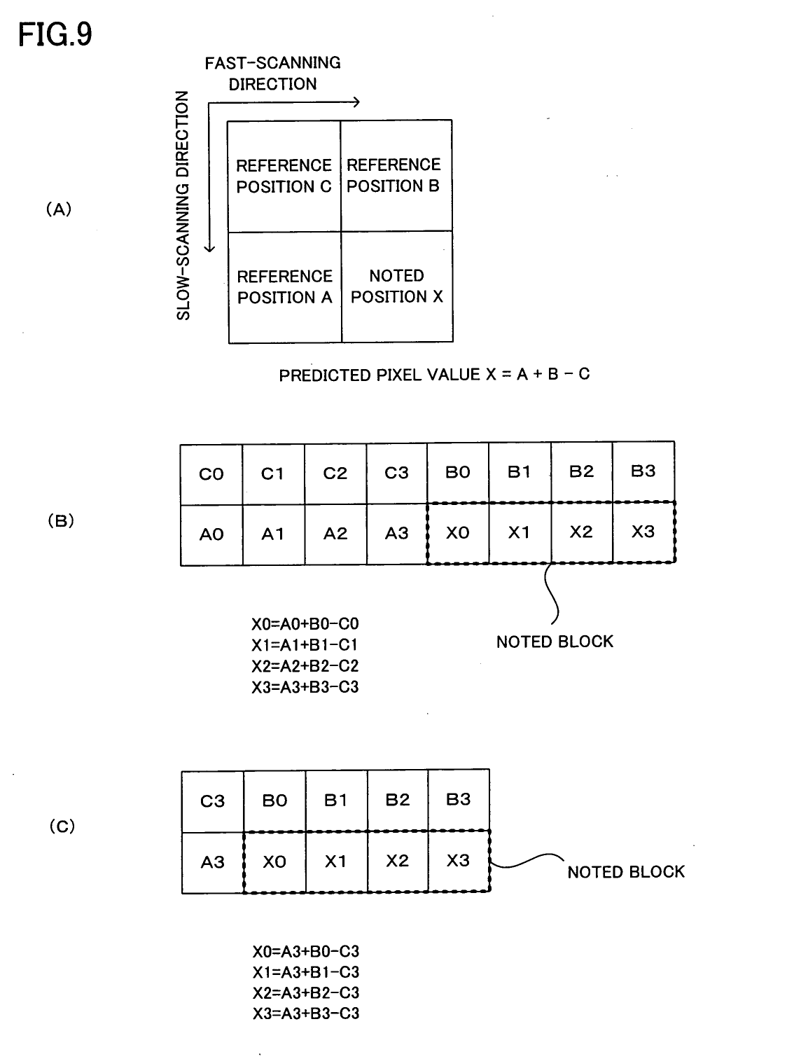

In predictive encoding, as illustrated in FIG. 9(A), predicted data is created for data elements in a noted position X by using data elements in reference positions A through C around, and the difference (prediction error) between the created predicted data and the data elements in the noted position X (noted data) is encoded.

When this encoding is to be done block by block as illustrated in FIG. 9(A), with the block in the noted position X being supposed to be the noted block, the whole block in the reference position A as a reference block A, the whole block in the reference position B as a reference block B and the whole block in the reference position C as a reference block C, predicted values and computed for the pixels contained the noted block by using reference pixel values (A0 through A3, B0 through B3 and C0 through C3) in corresponding positions in the reference blocks as illustrated in FIG. 9(B).

Also, as illustrated in FIG. 9(C), the block in the reference position A may be degenerated to a single pixel value (the final pixel value A3 of the reference block A) and the block in the reference position C may be degenerated to a single pixel value (the final pixel value C3 of the reference block C).

The prediction method of FIG. 9(B) has a characteristic that, though it is consonant with parallelization by multi-pit processing, it is lower in compression rate than the prediction method of FIG. 9(C). Since neither prediction method uses pixel values in the same block for predicting pixel values in the block, both methods are free from feedback loop generation and make faster processing possible.

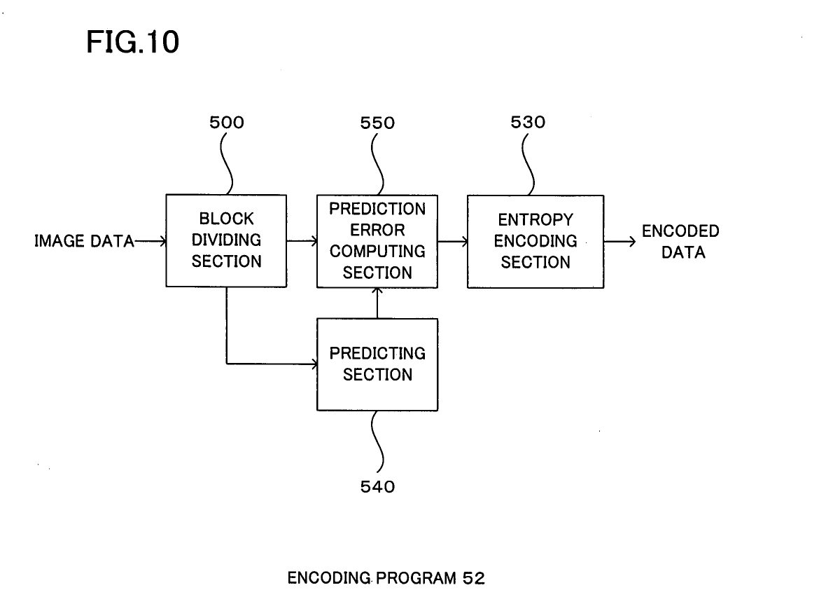

FIG. 10 typically illustrates the functional configuration of a second encoding program 52. Incidentally, the constituent elements which are substantially the same as their counterparts in FIG. 2 are assigned respectively the same signs.

As shown in FIG. 10, the second encoding program 52 has a configuration which represents elimination of the substitution determining section 510 and the run counter 520 from and the addition of a predicting section 540 and a prediction error computing section 550 to the encoding program 5 of FIG. 2.

The predicting section 540 creates predicted data of the noted block on the basis of individual blocks created by the block dividing section 500, and outputs the created predicted data to the prediction error computing section 550. Creation of the predicted data uses data elements contained in other blocks than the noted block.

The predicting section 540 of this example computes the predicted data pieces (X0 through X3) of the noted block from the pixel values of the blocks of the reference position A (A0 through A3), those of the reference position B (B0 through B3) and those of the reference position C (C0 through C3) by using the equation shown in FIG. 9(B).

The prediction error computing section 550 computes the prediction error of the noted block for individual blocks created by the block dividing section 500.

The prediction error computing section 550 in this example computes the differences between the noted block inputted from the block dividing section 500 and the predicted data (X0 through X3) of the noted block inputted from the predicting section 540, and outputs the computed differences (prediction errors) to the entropy encoding section 530 as symbols to be encoded.

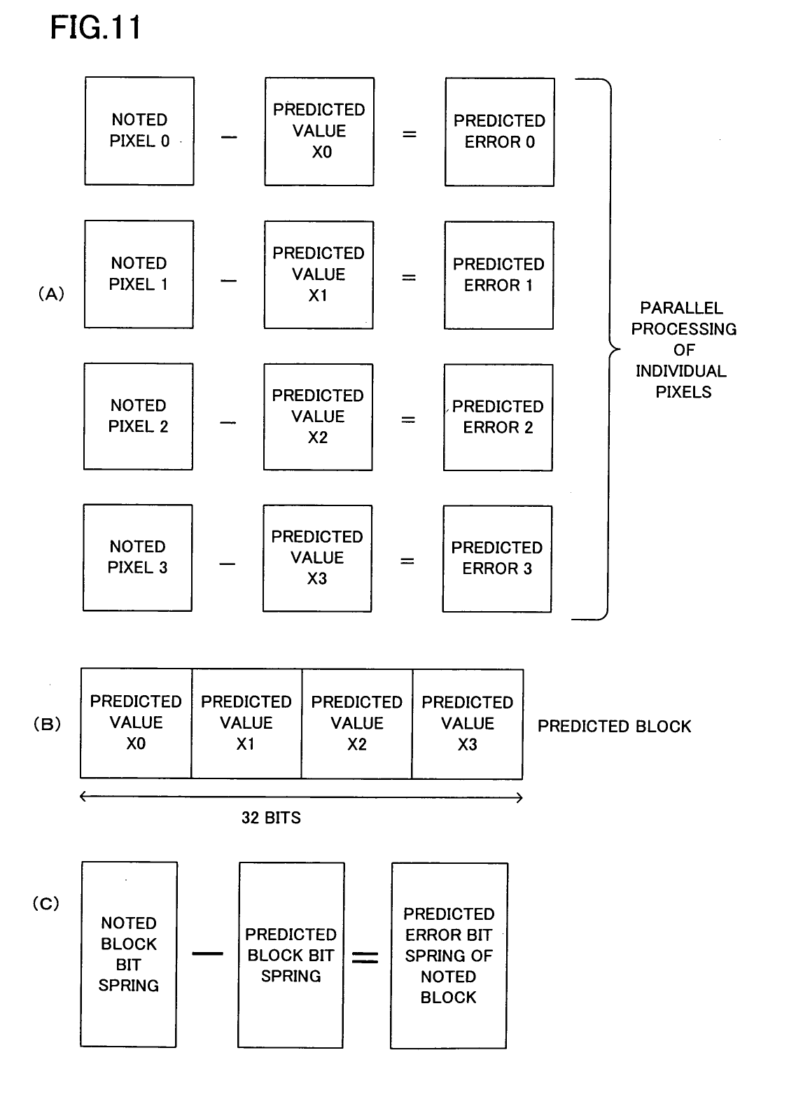

The prediction error computing section 550 in this example, as illustrated in FIG. 11(A), computes the differences between the values of pixels contained in the noted block (noted pixel 0 through noted pixel 3) and the predicted values contained in the predicted data (the predicted value X0 through the predicted value X3), and makes the computed differences (prediction error 0 through prediction error 3) as symbols to be encoded.

Incidentally, the prediction error computing section 550, regarding the predicted data pieces (the predicted value X0 through the predicted value X3) inputted from the predicting section 540 as a bit string of a single block (predicted block) as shown in FIG. 11(B), may as well compute the difference between the bit string (an arrayed bit string of the noted pixel 0 through the noted pixel 3) of the noted block and the bit string of the predicted block as the bit string prediction errors of the noted block as shown in FIG. 11(C). In this case, a carry-down may occur between pixels, but the resultant deterioration of picture quality would be within a tolerable range. Also, the bit string of prediction errors may be divided into individual pixels to constitute symbols to be encoded or keep it undivided and make its whole a symbol to be encoded. In the collective processing bit strings of the predicted block, as the processing to compute predicted data shown in FIG. 9(B) can also compute the bit strings of X0 through X3 by adding or subtracting the bit string of A0 through A3, that of B0 through B3 and that of C0 through C3, it is well compatible with the system of FIG. 11(C) and accordingly for packaging very well.

The second encoding program 52, as its processes predictive encoding on a block-by-block basis in this way, may realize predictive encoding at high speed.

[Variation 3]

In a third variation, the run-length encoding system and the predictive encoding system are combined. When combining the run-length encoding system and the predictive encoding system, the blocks of the two systems need not be identical. For instance, as the run-length encoding system is subject to a lighter processing load than the predictive encoding system, it can be balanced at a lower level of parallelism (namely a smaller block size) than the predictive encoding system.

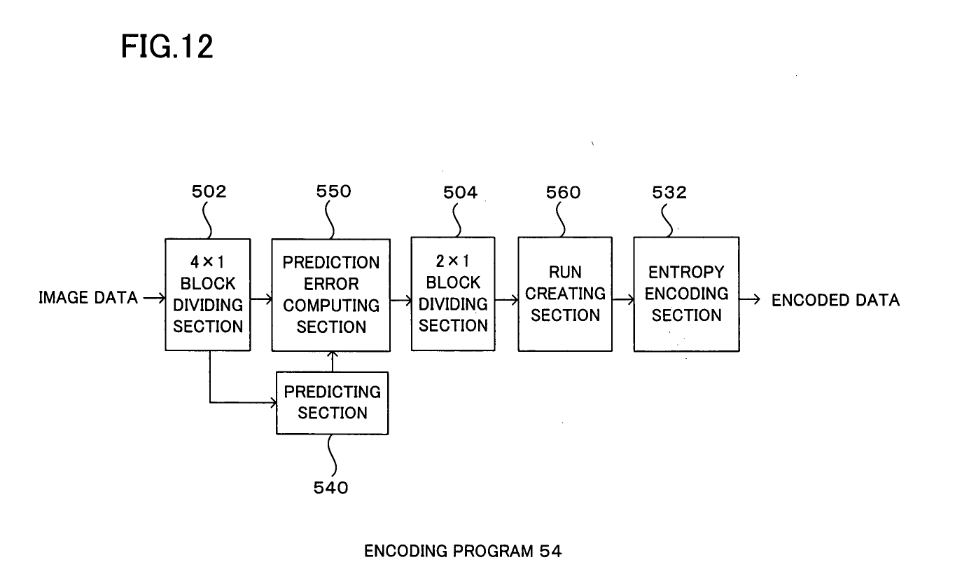

FIG. 12 typically illustrates the functional configuration of a third encoding program 54. Incidentally, out of the constituent elements in this figure, those substantially the same as their counterparts in FIG. 2 or FIG. 10 are assigned respectively the same signs.

As illustrated in FIG. 12, the third encoding program 54 has a 4×1 block dividing section 502, the predicting section 540, the prediction error computing section 550, a 2×1 block dividing section 504, a run creating section 560 and a second entropy encoding section 532.

The 4×1 block dividing section 502 divides the input image data into four-pixel blocks in the fast-scanning direction and into one-pixel blocks in the slow-scanning direction.

The 2×1 block dividing section 504 divides the input image data into two-pixel blocks in the fast-scanning direction and into one-pixel blocks in the slow-scanning direction.

Thus, when the run-length encoding system is applied, smaller blocks (½ size in this example) are used than when the predictive encoding system is applied.

The 2×1 block dividing section 504 creates 2×1 blocks of prediction errors by putting together two-pixel equivalents, arranged in the fast-scanning direction, of the prediction errors of the pixel computed by the prediction error computing section 550.

The run creating section 560 counts runs with respect to prediction errors for every 2×1 blocks. Thus, the run creating section 560 has the functions of the substitution determining section 510 and the run counter 520 of FIG. 2, and counts runs with respect to prediction errors.

The entropy encoding section 532 encodes with variable-length codes the run data of prediction errors (the number of runs and prediction errors or all the prediction errors in the block) created by the run creating section 560.

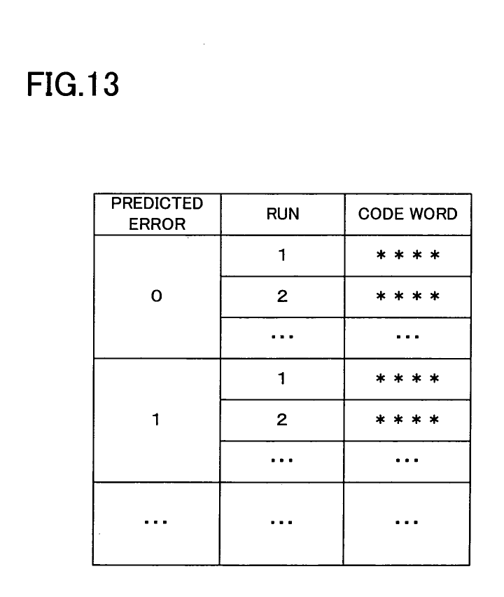

The entropy encoding section 532 in this example is supposed to use Huffman codes, for which the information source is enlarged by using two symbols as one new symbol, in variable-length encoding. More specifically, as illustrated in FIG. 13, the entropy encoding section 532 designs a code table of Huffman codes with combinations of the values of prediction errors and runs as symbols, and outputs code words matching the values of prediction errors and runs by using this code table.

[Other Variations]

To add, though symbols to be encoded are entropy-encoded with variable-length codes in every case of the foregoing exemplary embodiment and variations, the applicable encoding systems are not limited to them, for instance, these symbols (runs, pixel values, prediction errors and so forth) may as well be outputted as codes.

The foregoing description of the exemplary embodiment of the present invention has been provided for the purposes of illustration and description. It is not intended to be exhaustive or to limit the present invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An encoding apparatus comprising:
a block dividing unit that divides an inputted data file into blocks each comprising a plurality of data elements arranged in the order of encoding;
a predicted data creating unit that creates predicted data for each of the blocks resulting from the division by the block dividing unit on the basis of data elements contained in other blocks;
a comparing unit that compares the predicted data created by the predicted data creating unit with data elements contained in the blocks; and
a code creating unit that creates codes for the inputted data file on the basis of results of the comparison by the comparing unit.

2. The encoding apparatus according to claim 1,
wherein the predicted data creating unit, when creating predicted data of a noted block, uses one data element processed immediately before the noted block as predicted data;
the comparing unit compares each of the data elements contained in the noted block with the predicted data; and
the code creating unit, when the predicted data is found identical with all the data elements contained in the noted block, creates, as a code of the noted block, a code indicating the rightness of the prediction.

3. The encoding apparatus according to claim 1,
wherein the predicted data creating unit, when creating predicted data of a noted block, determines one piece of predicted data for the noted block and creates a predicted block in which a plurality of the determined predicted data pieces are arrayed;
the comparing unit compares the predicted block created by the predicted data creating unit with the noted block; and
the code creating unit, when the predicted block and the noted block are found identical, creates, as the code of the noted block, a code indicating rightness of the prediction.

4. The encoding apparatus according to claim 1,
wherein the predicted data creating unit, when creating predicted data of a noted block, uses a block processed immediately before the noted block as predicted data;
the comparing unit compares a bit string of the noted block with a bit string of the immediately preceding block; and
the code creating unit, when the bit string of the noted block and the bit string of the immediately preceding block are found identical, creates, as a code of the noted block, a code indicating rightness of the prediction.

5. The encoding apparatus according to claim 1,
wherein the comparing unit compares in parallel the plurality of data elements contained in the blocks with the predicted data matching the respective data elements.

6. The encoding apparatus according to claim 1, further comprising:
a prediction error computing unit that computes prediction errors on a block-by-block basis,
wherein the code creating unit creates a code indicating rightness of the prediction when the predicted data and all the data elements contained in the block are found identical, or creates codes indicating the prediction errors computed by the prediction error computing unit when the predicted data and any of the data elements contained in the blocks are found unidentical.

7. An encoding apparatus comprising:
a block dividing unit that divides an inputted data file into blocks each including a plurality of data elements arranged in the order of encoding;
a predicted data creating unit that creates predicted data for each of the blocks resulting from division by the block dividing unit on the basis of data elements contained in other blocks;
a prediction error computing unit that computes prediction errors on a block-by-block basis on the basis of the predicted data created by the predicted data creating unit; and
a code creating unit that creates codes for the inputted data file on the basis of the prediction errors computed by the prediction error computing unit.

8. An encoding method, comprising:
dividing an inputted data file into blocks each including a plurality of data elements arranged in the order of encoding;
creating predicted data for each of the blocks resulting from the division on the basis of data elements contained in other blocks;
comparing the created predicted data with data elements contained in the blocks; and
creating codes for the inputted data file on the basis of results of the comparison.

9. A computer readable medium storing a program causing a computer to execute a process, the process comprising:
dividing an inputted data file into blocks each including a plurality of data elements arranged in the order of encoding;
creating predicted data for each of the blocks resulting from the division on the basis of data elements contained in other blocks;
comparing the created predicted data with data elements contained in the blocks; and
creating codes for the inputted data file on the basis of results of the comparison.

10. A computer data signal embodied in a carrier wave for enabling a computer to perform a process for encoding, the process comprising:
dividing an inputted data file into blocks each including a plurality of data elements arranged in the order of encoding;
creating predicted data for each of the blocks resulting from the division on the basis of data elements contained in other blocks;
comparing the created predicted data with data elements contained in the blocks; and
creating codes for the inputted data file on the basis of results of the comparison.
